(19) United States
(12) Patent Application Publication
(10) Pub. No.: US 2024/0225097 A1
(43) Pub. Date: Jul. 11, 2024

(54) AEROSOL GENERATING DEVICE

(71) Applicant: KT&G CORPORATION, Daejeon (KR)

(72) Inventor: Hwikyeong AN, Seoul (KR)

(73) Assignee: KT&G CORPORATION, Daejeon (KR)

(21) Appl. No.: 18/407,263

(22) Filed: Jan. 8, 2024

(30) Foreign Application Priority Data
Jan. 9, 2023 (KR) 10-2023-0003105
May 9, 2023 (KR) 10-2023-0059914

(51) Int. Cl. A24F 40/40; A24F 40/60; G08B 6/00

(52) U.S. Cl. CPC A24F 40/40; A24F 40/60; G08B 6/00

(57) ABSTRACT

An aerosol generating device is disclosed. The aerosol generating device includes: a heater mounted to the body and configured to heat the aerosol generating substance; a fixing body installed inside the body; a holder provided on the fixing body; and a vibrator coupled to the holder, wherein: the holder includes a support portion that protrudes from the fixing body and extends along a circumferential direction of the vibrator, and a seating portion that is disposed inside the support portion and supports the vibrator; and the support portion includes a first opening formed in a circumferential direction of the support portion.

### CROSS-REFERENCE TO RELATED APPLICATIONS

Pursuant to 35 U.S.C. § 119(a), this application claims the benefit of earlier filing date and right of priority to Korean Patent Application Nos. 10-2023-0003105, filed on Jan. 9, 2023, and 10-2023-0059914, filed on May 9, 2023, the contents of which are all hereby incorporated by reference herein in their entirety.

### TECHNICAL FIELD

The present disclosure relates to an aerosol generating device.

### BACKGROUND ART

An aerosol generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol generating devices has been conducted.

Such an aerosol generating device includes an output device configured to output information to a user, and a vibrator that outputs vibration can be used as the output device. The output device can provide a notification function to the user using vibration generated by the operation of the vibrator.

When there is a gap in a fixing structure for securing an aerosol generating device, hitting noise (BSR (Buzz, Squeak, Rattle) noise) may be generated due to being hit on the fixing structure by a vibrator while vibrating, which may result in reducing the lifespan of the vibrator and causing damage to the fixing structure.

### DISCLOSURE

### Technical Problem

It is an objective of the present disclosure to solve the above and other problems.

It is another objective of the present disclosure to provide an aerosol generating device that can allow a vibrator to be fixed or secured without an additional shock absorber.

It is yet another objective of the present disclosure to provide an aerosol generating device that can allow a vibrator to be firmly and stably fixed.

### Technical Solution

According to one aspect of the subject matter described in this application: an aerosol generating device includes: a heater mounted to the body and configured to heat the aerosol generating substance; a fixing body installed inside the body; a holder provided on the fixing body; and a vibrator coupled to the holder. The holder includes: a support portion that protrudes from the fixing body and extends along a circumferential direction of the vibrator; and a seating portion that is disposed inside the support portion and supports the vibrator. The support portion includes a first opening formed in a circumferential direction of the support portion.

### Advantageous Effects

According to at least one of the embodiments of the present disclosure, it is possible to allow a vibrator to be firmly and stably fixed.

According to at least one of the embodiments of the present disclosure, it is possible to prevent a decrease in lifespan of a vibrator and damage to a fixing unit due to being hit by the vibrator.

According to at least one of the embodiments of the present disclosure, it is possible to effectively transfer vibration of a vibrator while fixing the vibrator securely, allowing information to be correctly notified to a user.

According to at least one of the embodiments of the present disclosure, it is possible to secure a vibrator without an additional shock absorber, thereby simplifying the structure of a fixing unit and reducing manufacturing costs.

According to at least one of the embodiments of the present disclosure, it is possible to allow a vibrator to be easily attached and detached to and from a fixing unit, thereby increasing the efficiency of product production.

The additional scope of applicability of the present disclosure will be apparent from the following detailed description. However, those skilled in the art will appreciate that various modifications and alterations are possible, without departing from the idea and scope of the present disclosure, and therefore it should be understood that the detailed description and specific embodiments, such as the preferred embodiments of the present disclosure, are provided only for illustration.

### DESCRIPTION OF DRAWINGS

FIGS. 1 to 3 are views illustrating examples of an aerosol generating device according to embodiments of the present disclosure.

FIG. 4 is a block diagram of an aerosol generating device according to an embodiment of the present disclosure.

FIG. 5 is a front perspective view of an aerosol generating device according to an embodiment of the present disclosure.

FIGS. 6 to 9 are respectively a front perspective view, an enlarged view, a front view, and a rear view of a fixing unit included in an aerosol generating device according to an embodiment of the present disclosure.

FIG. 10 is a view illustrating a vibrator coupled to a fixing unit according to an embodiment of the present disclosure.

FIG. 11 and FIG. 12 are views illustrating a state in which the vibrator of FIG. 10 is coupled to the fixing unit.

FIG. 13 and FIG. 14 are cross-sectional views of the fixing unit.

### MODE FOR INVENTION

Description will now be given in detail according to exemplary embodiments disclosed herein, with reference to the accompanying drawings. For the sake of brief description with reference to the drawings, the same or equivalent components are provided with the same or similar reference numerals, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms “first”, “second”, etc. may be used herein to describe various elements, these elements should not be limited by these terms. These terms are only used to distinguish one element from another.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, a singular representation is intended to include a plural representation unless the context clearly indicates otherwise.

FIGS. 1 to 3 are views illustrating examples of an aerosol generating device according to embodiments of the present disclosure. According to various embodiments of the present disclosure, an aerosol generating device 10 may include a body 100 and/or a cartridge 200.

The aerosol generating device 10 shown in FIGS. 1 to 3 may have a fixing unit 300 in the body 100. The aerosol generating device 10 may vibrate as a vibrator 400 accommodated in the fixing unit 300 operates, allowing information to be provided to a user.

Referring to FIG. 1, the aerosol generating device 10 according to an embodiment of the present discourse may include a body 100 having an insertion space to allow a stick 20 to be inserted into the space defined by a housing 101.

The stick 20 may be similar to a general combustive cigarette. For example, the stick 20 may be divided into a first portion including an aerosol generating substance and a second portion including a filter, etc. Alternatively, the second portion of the stick 20 may also include an aerosol generating substance. For example, an aerosol generating substance made in the form of granules or capsules may be inserted into the second portion.

The entire first portion may be inserted into the aerosol generating device 10, and the second portion may be exposed to the outside. Alternatively, only a portion of the first portion may be inserted into the aerosol generating device 10, or the first portion and a portion of the second portion may be inserted into the aerosol generating device 10. A user may inhale an aerosol while holding the second portion in his or her mouth. Here, the aerosol may be generated as external air passes through the first portion, and the generated aerosol may pass through the second portion to be delivered to the mouth of the user.

The body 100 may have a structure that allows external air to be introduced therein with the stick 20 being inserted. Here, the external air introduced into the body 100 may pass through the stick 20 to flow into the mouth of the user.

A heater may be disposed in the body 100 at a position corresponding to a position of the stick 20 when the stick 20 is inserted into the body 100. In the drawing, although the heater is illustrated as an electrically conductive heater 110 including an electrically conductive track of a needle shape, the present disclosure is not limited thereto. The aerosol generating device 10 may include an induction coil (not shown) surrounding the insertion space, and the heater 110, which is a susceptor, may generate heat by a magnetic field flowing through the induction coil. The heater may include a tube-shaped heating element, a plate-shaped heating element, a needle-shaped heating element, or a rod-shaped heating element.

The heater may heat an inside and/or an outside of the stick 20 by using power supplied from a battery 16. In this case, an aerosol may be generated in the heated stick 20. Here, the user may puff on one end of the stick 20 with his or her mouth to inhale a tobacco-flavored aerosol.

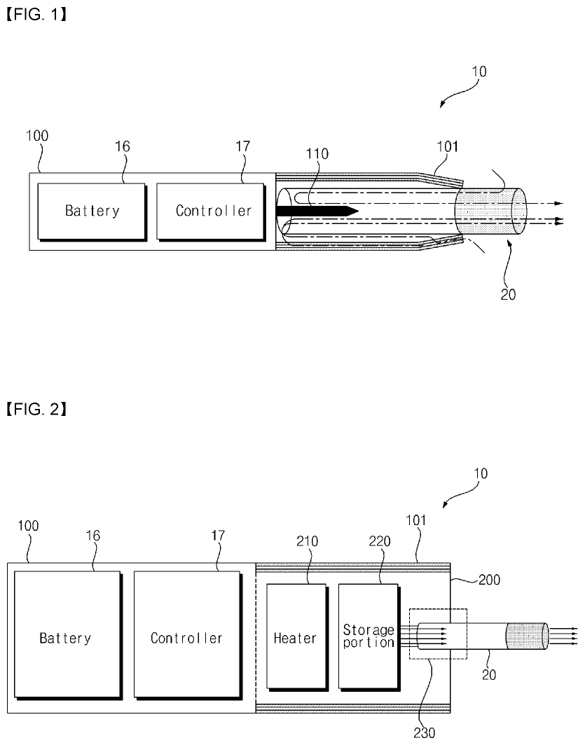

Referring to FIG. 2, the aerosol generating device 10 according to an embodiment of the present disclosure may include a body 100 that supports a cartridge 200 and the cartridge 200 that contains an aerosol generating substance.

In one embodiment, the cartridge 200 may be configured to be detachably attached to the body 100. In another embodiment, the cartridge 200 may be integrally formed with the body 100. For example, at least a portion of the cartridge 200 may be inserted into an inner space defined by a housing 101 of the body 100, allowing the cartridge 200 to be mounted to the body 100.

The body 100 may have a structure that allows external air to be introduced therein with the cartridge 200 inserted. Here, the external air introduced into the body 100 may pass through the cartridge 200 to flow into the mouth of a user.

The controller 17 may determine mounting/removal of the cartridge 200 to/from the body 100 through a cartridge detection sensor included in a sensor module 15. For example, the cartridge detection sensor may transmit a pulse current through one terminal connected to the cartridge 200. In this case, the cartridge detection sensor may detect connection or disconnection of the cartridge 200 based on whether or not the pulse current is received through another terminal.

The cartridge 200 may include a heater 210 configured to heat an aerosol generating substance and/or a storage portion 220 configured to contain the aerosol generating substance. For example, a liquid delivery element impregnated with (containing) the aerosol generating substance may be disposed in the storage portion 220. An electrically conductive track of the heater 210 may have a structure wound around the liquid delivery element. As the liquid delivery element is heated by the heater 210, an aerosol may be generated. Here, the liquid delivery element may include a wick made of, for example, cotton fiber, ceramic fiber, glass fiber, or porous ceramic.

The cartridge 200 may include an insertion space 230 configured to allow a stick 20 to be inserted therein. For example, the cartridge 200 may include an insertion space defined by an inner wall (not shown) extending in the circumferential direction along a direction in which the stick 20 is inserted. Here, an inside of the inner wall may be open vertically to define the insertion space. The stick 20 may be inserted into the insertion space 230 defined by the inner wall.

The insertion space into which the stick 20 is inserted may have a shape corresponding to the shape of a portion of the stick 20 that is inserted into the insertion space. For example, when the stick 20 has a cylindrical shape, the insertion space may be formed in a cylindrical shape.

When the stick 20 is inserted into the insertion space, an outer circumferential surface of the stick 20 may be surrounded by the inner wall to be in contact with the inner wall.

The stick 20 may be similar to a general combustive cigarette. For example, the stick 20 may be divided into a first portion including an aerosol generating substance and a second portion including a filter, etc. Alternatively, the second portion of the stick 20 may also include an aerosol generating substance. For example, an aerosol generating substance made in the form of granules or capsules may be inserted into the second portion.

The entire first portion may be inserted into the insertion space 230, and the second portion may be exposed to the outside. Alternatively, only a portion of the first portion may be inserted into the insertion space 230, or the first portion and a portion of the second portion may be inserted into the insertion space 230. A user may inhale an aerosol while holding the second portion in his or her mouth. Here, the aerosol may be generated as external air passes through the first portion, and the generated aerosol may pass through the second portion to be delivered to the mouth of the user.

The user may inhale an aerosol while holding one end of the stick 20 in his or her mouth. The aerosol generated by the heater 210 may pass through the stick 20 to be delivered to the mouth of the user. Here, a material included in the stick 20 may be added to the aerosol while passing through the stick 20, and the material-added aerosol may be inhaled into the mouth of the user through the one end of the stick 20.

Referring to FIG. 3, the aerosol generating device 10 according to an embodiment of the present disclosure may include a body 100 that supports a cartridge 200 and the cartridge 200 that contains an aerosol generating substance. The body 100 may be configured to allow a stick 20 to be inserted in an insertion space 130.

The aerosol generating device 10 may include a first heater configured to heat the aerosol generating substance stored in the cartridge 200. For example, when a user puffs on one end of the stick 20 with his or her mouth, an aerosol generated by the first heater may pass through the stick 20. Here, a flavoring may be added to the aerosol while passing through the stick 20. The flavored aerosol may be inhaled into the mouth of the user through the one end of the stick 20.

Alternatively, in another embodiment, the aerosol generating device 10 may include a first heater configured to heat the aerosol generating substance stored in the cartridge 200 and a second heater configured to heat the stick 20 inserted into the body 100. For example, the aerosol generating device 10 may generate an aerosol by heating the aerosol generating substance stored in the cartridge 200 and the stick 20 through the first heater and the second heater, respectively.

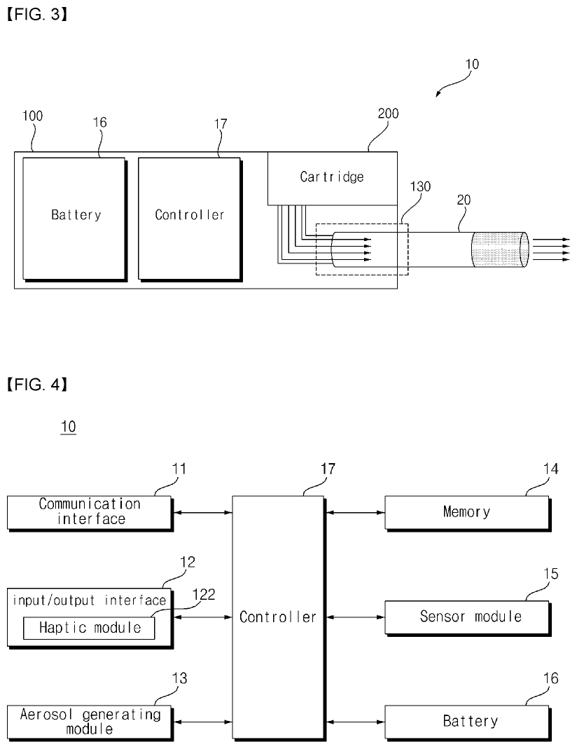

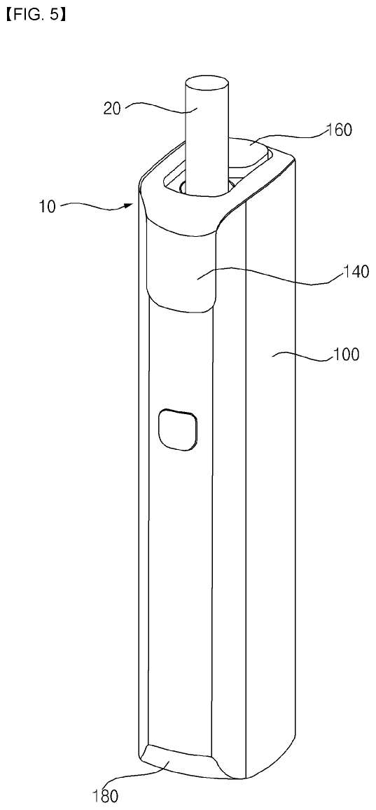

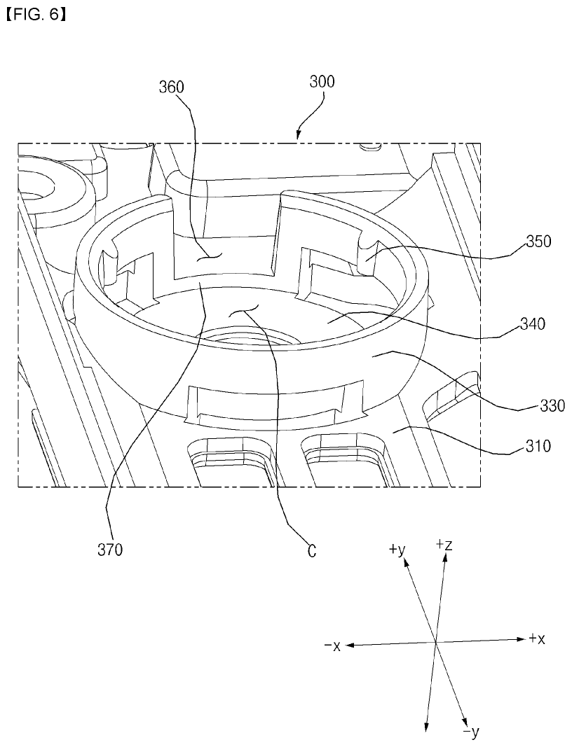

FIG. 4 is a block diagram of an aerosol generating device according to an embodiment of the present disclosure.

Referring to FIG. 4, the aerosol generating device 10 may include a communication interface 11, an input/output interface 12, an aerosol generating module 13, a memory 14, a sensor module 15, a battery 16, and/or a controller 17. However, the internal structure of the aerosol generating device 10 is not limited to the internal structure shown in FIG. 4. That is, it will be understood by one of ordinary skill in the art that some of the components shown in FIG. 4 may be omitted or new components may be added according to the design of the aerosol generating device 10.

In one embodiment, the aerosol generating device 10 may consist of only a body 100. In this case, the components included in the aerosol generating device 10 may be disposed in the body 100. In another embodiment, the aerosol generating device 10 may consist of a cartridge 200, which contains an aerosol generating substance, and a body 100. In this case, the components included in the aerosol generating device 10 may be disposed in at least one of the body 100 and the cartridge 200.

The communication interface 11 may include at least one communication module for communication with an external device and/or a network. For example, the communication interface 11 may include a communication module for wired communication such as a Universal Serial Bus (USB). For example, the communication interface 11 may include a communication module for wireless communication such as Wireless Fidelity (Wi-Fi), Bluetooth, Bluetooth Low Energy (BLE), ZigBee, or Near-Field Communication (NFC).

The input/output interface 12 may include an output device 122 configured to output information to a user. For example, the output device 122 may include a haptic module 122 to output tactile information (vibration information) such haptic effects. The haptic module 122 may include a fixing unit 300 and a vibrator 400.

The output device 122 may further include a display device to output visual information, such as a display or a light-emitting diode (LED), and an audio device to output auditory information, such as a speaker or a buzzer.

The input/output interface 12 may also include an input device configured to receive a command from a user. For example, the input device may include a touch panel, a physical button, a microphone, or the like.

The aerosol generating module 13 may generate an aerosol from an aerosol generating substance. Here, the aerosol generating substance may be a substance in a liquid state, a solid state, or a gel state, which is capable of generating an aerosol, or a combination of two or more aerosol generating substances.

In one embodiment, the liquid aerosol generating substance may be a liquid including a tobacco-containing material having a volatile tobacco flavor component. In another embodiment, the liquid aerosol generating substance may be a liquid including a non-tobacco material. For example, the liquid aerosol generating substance may include water, solvents, nicotine, plant extracts, flavorings, flavoring agents, vitamin mixtures, etc.

The solid aerosol generating substance may include a solid material based on a tobacco raw material such as a reconstituted tobacco sheet, shredded tobacco, or granulated tobacco. In addition, the solid aerosol generating substance may include a solid material having a taste control agent and a flavoring material. For example, the taste control agent may include calcium carbonate, sodium bicarbonate, calcium oxide, etc. For example, the flavoring material may include a natural material such as herbal granules, or may include a material such as silica, zeolite, or dextrin, which includes an aroma ingredient.

In addition, the aerosol generating substance may further include an aerosol-forming agent such as glycerin or propylene glycol.

The aerosol generating module 13 may include at least one heater.

The aerosol generating module 13 may include an electro-resistive heater. For example, the electro-resistive heater may include at least one electrically conductive track. The electro-resistive heater may be heated by the current flowing through the electrically conductive track. Here, the aerosol generating substance may be heated by the heated electro-resistive heater.

The electrically conductive track may include an electro-resistive material. In one example, the electrically conductive track may be formed of a metal material. In another example, the electrically conductive track may be formed of a ceramic material, carbon, a metal alloy, or a composite of a ceramic material and metal.

The electro-resistive heater may include an electrically conductive track that is formed in any of various shapes. For example, the induction heater may include an electrically conductive coil. For example, the electrically conductive track may have any one of a tubular shape, a plate shape, a needle shape, a rod shape, and a coil shape.

The aerosol generating module 13 may include a heater that uses an induction heating method, namely, an induction heater. For example, the induction heater may include an electrically conductive coil. The induction heater may generate an alternating magnetic field, which periodically changes in direction, by adjusting the current flowing through the electrically conductive coil. In this case, when the alternating magnetic field is applied to a magnetic body, energy loss may occur in the magnetic body due to eddy current loss and hysteresis loss, and the lost energy may be released as thermal energy. Accordingly, the aerosol generating substance located adjacent to the magnetic body may be heated. Here, an object that generates heat due to the magnetic field may be referred to as a susceptor.

Meanwhile, the aerosol generating module 13 may generate ultrasonic vibrations to thereby generate an aerosol from the aerosol generating substance.

The aerosol generating module 13 may be referred to as a cartomizer, an atomizer, or a vaporizer.

When the aerosol generating device 10 consists of a cartridge 200, which contains an aerosol generating substance, and a body 100, the aerosol generating module 13 maybe disposed in at least one of the body 100 and the cartridge 200.

The memory 14 may be configured to store a program for processing and controlling each signal in the controller 17. The memory 1400 may store data processed by the controller 17 and data to be processed.

For example, the memory 14 may store therein applications designed for the purpose of performing various tasks that can be processed by the controller 17. The memory 14 may selectively provide some of the stored applications in response to a request from the controller 17.

For example, the memory 14 may store therein data regarding an operation time of the aerosol generating device 10, the maximum number of puffs, the current number of puffs, the number of charging times of the battery 16, the number of discharging times of the battery 16, at least one temperature profile, the user's inhalation pattern, charging/discharging, etc. Here, “puff(s)” may refer to inhalation by the user, and “inhalation” may refer to the user's act of taking air or other substances into the user's oral cavity, nasal cavity, or lungs through the user's mouth or nose.

The memory 14 may include at least one of volatile memory (e.g., dynamic random access memory (DRAM), static random access memory (SRAM), or synchronous dynamic random access memory (SDRAM)), nonvolatile memory (e.g., flash memory), a hard disk drive (HDD), and a solid-state drive (SSD).

The memory 14 may be disposed in at least one of the body 100 and the cartridge 200. The memory 14 may be disposed in each of the body 100 and the cartridge 200. For example, the memory of the body 100 may store information regarding components that are disposed in the body 100, for example, information regarding the full charge capacity of the battery 16. For example, the memory of the body 100 may store cartridge information received from the cartridge 200 previously or currently coupled to the body 100, and the memory of the cartridge 200 may store cartridge information including cartridge identification information (ID information), a cartridge type, and the like.

The sensor module 15 may include at least one sensor.

For example, the sensor module 15 may include a sensor configured to sense a puff (hereinafter referred to as a “puff sensor”). In this case, the puff sensor may be implemented as a proximity sensor, such as an IR sensor, a pressure sensor, a gyro sensor, an acceleration sensor, a magnetic field sensor, or the like.

For example, the sensor module 15 may include a sensor configured to sense the temperature of the heater included in the aerosol generating module 13 and the temperature of the aerosol generating substance (hereinafter referred to as a “temperature sensor”).

For example, when a stick is configured to be inserted into the body of the aerosol generating device 10, the sensor module 15 may include a sensor configured to sense insertion of the stick (hereinafter referred to as a “stick detection sensor”).

For example, when the aerosol generating device 10 includes a cartridge 200, the sensor module 15 may include a sensor configured to sense mounting/removal of the cartridge 200 to/from the body 100, the position of the cartridge 200 (hereinafter referred to as a “cartridge detection sensor”).

Here, the stick detection sensor and/or the cartridge detection sensor may be implemented as an inductance-based sensor, a capacitance sensor, a resistance sensor, or a hall IC using a hall effect. In some embodiments, the cartridge detection sensor may include a connection terminal. The connection terminal may be disposed in the body 100, and may be electrically connected to electrodes provided in the cartridge 200 when the cartridge 200 is coupled to the body 100.

For example, the sensor module 15 may include a voltage sensor configured to sense a voltage applied to a component (e.g., the battery 16) provided in the aerosol generating device 10 and/or a current sensor configured to sense a current.

For example, the sensor module 15 may include at least one sensor configured to sense movement of the body 100 and/or the cartridge 200 of the aerosol generating device 10 (hereinafter referred to as a “motion sensor”). Here, the motion sensor may be implemented as at least one of a gyro sensor and an acceleration sensor. The motion sensor may be disposed in at least one of the body 100 and the cartridge 200.

The battery 16 may supply power used for the operation of the aerosol generating device 10 under the control of the controller 17. The battery 16 may supply power to other components provided in the aerosol generating device 10. For example, the battery 16 may provide power to the communication module included in the communication interface 11, the output device included in the input/output interface 12, the heater included in the aerosol generating module 13, and the like.

The battery 16 may be a rechargeable battery or a disposable battery. For example, the battery 16 may be a lithium-ion battery or a lithium polymer (Li-polymer) battery, but is not limited thereto. For example, when the battery 16 is rechargeable, a charge rate (C-rate) of the battery 16 may be 10 C, and a discharge rate (C-rate) of the battery 16 may be 10 C to 20 C. However, the present disclosure is not limited thereto. In addition, for stable use, the battery 16 may be designed to retain 80% or more of its original capacity at 2,000 full charge and discharge cycles.

The aerosol generating device 10 may further include a battery protection circuit module (PCM), which is a circuit for protecting the battery 16. The battery protection circuit module (PCM) may be disposed adjacent to the upper surface of the battery 16. For example, in order to prevent overcharging and overdischarging of the battery 16, the battery protection circuit module (PCM) may cut off the electrical path to the battery 16 when a short circuit occurs in a circuit connected to the battery 16, when an overvoltage is applied to the battery 16, or when an excessive current flows through the battery 16.

The aerosol generating device 10 may further include a charging terminal to which power supplied from the outside is input. For example, a charging terminal may be provided at one side of the body 100 of the aerosol generating device 10. The aerosol generating device 10 may charge the battery 16 using the power supplied through the charging terminal. In this case, the charging terminal may be configured as a wired terminal for USB communication, a pogo pin, or the like.

The aerosol generating device 10 may wirelessly receive power supplied from the outside through the communication interface 11. For example, the aerosol generating device 10 may wirelessly receive power using an antenna included in the communication module for wireless communication. For example, the aerosol generating device 10 may charge the battery 16 using the wirelessly supplied power.

The controller 17 may control the overall operation of the aerosol generating device 10. The controller 17 may be connected to each of the components provided in the aerosol generating device 10. The controller 17 may transmit and/or receive a signal to and/or form each of the components, thereby controlling the overall operation of the components.

The controller 17 may include at least one processor. The controller 17 may use the processor to control the overall operation of the aerosol generating device 10. Here, the processor may be a general processor such as a central processing unit (CPU). Alternatively, the processor may be a dedicated device such as an application-specific integrated circuit (ASIC) or may be any of other hardware-based processors.

The controller 17 may perform any one of a plurality of functions of the aerosol generating device 10. For example, the controller 17 may perform any one of a plurality of functions of the aerosol generating device 10 (e.g., a preheating function, a heating function, a charging function, and a cleaning function) according to the state of each of the components provided in the aerosol generating device 10, a user command received through the input/output interface 12, etc.

The controller 17 may control the operation of each of the components provided in the aerosol generating device 10 based on data stored in the memory 14. For example, the controller 17 may control such that a predetermined amount of power is supplied from the battery 16 to the aerosol generating module 13 for a predetermined time based on data stored in the memory 14 such as the temperature profile and the user's inhalation pattern.

The controller 17 may determine the occurrence or non-occurrence of a puff using the puff sensor included in the sensor module 15. For example, the controller 17 may check a temperature change, a flow change, a pressure change, and a voltage change in the aerosol generating device 10 based on the values sensed by the puff sensor. For example, the controller 17 may determine the occurrence or non-occurrence of a puff based on the result of checking values sensed by the puff sensor.

The controller 17 may control the operation of each of the components provided in the aerosol generating device 10 according to the occurrence or non-occurrence of a puff and/or the number of puffs. For example, the controller 17 may control the temperature of the heater to be changed or maintained based on the temperature profile stored in the memory 14.

The controller 17 may control such that the supply of power to the heater is interrupted according to a predetermined condition. For example, the controller 17 may control such that the supply of power to the heater is interrupted when a stick is removed, when the cartridge 200 is removed, when the number of puffs reaches the predetermined maximum number of puffs, when a puff is not sensed for a predetermined time or longer, or when the remaining capacity of the battery 16 is less than a predetermined value.

The controller 17 may calculate the remaining capacity with respect to the full charge capacity of the battery 16. For example, the controller 17 may calculate the remaining capacity of the battery 16 based on the values sensed by the voltage sensor and/or the current sensor included in the sensor module 15.

The controller 17 may control such that power is supplied to the heater using at least one of a pulse width modulation (PWM) method or a proportional-integral-differential (PID) method.

For example, the controller 17 may control such that a current pulse having a predetermined frequency and a predetermined duty ratio is supplied to the heater using the PWM method. In this case, the controller 17 may control the power supplied to the heater by adjusting the frequency and the duty ratio of the current pulse.

For example, the controller 17 may determine a target temperature to be controlled based on the temperature profile. In this case, the controller 17 may control the power supplied to the heater using the PID method, which is a feedback control method using a difference value between the temperature of the heater and the target temperature, a value obtained by integrating the difference value with respect to time, and a value obtained by differentiating the difference value with respect to time.

For example, the controller 17 may control the power supplied to the heater based on the temperature profile. The controller 17 may control the length of a heating section for heating the heater, the amount of power supplied to the heater during the heating section, and the like. The controller 17 may control the power supplied to the heater based on the target temperature of the heater.

Although the PWM method and the PID method are described as exemplary methods of controlling the supply of power to the heater, the present disclosure is not limited thereto. Other various control methods, such as a proportional-integral (PI) method and a proportional-differential (PD) method, may be used.

The controller 17 may determine the temperature of the heater, and may control the power supplied to the heater according to the temperature of the heater. For example, the controller 17 may determine the temperature of the heater by checking a resistance value of the heater, a current flowing through the heater, and/or a voltage applied to the heater.

Meanwhile, the controller 17 may control such that power is supplied to the heater according to a predetermined condition. For example, when a cleaning function for cleaning the space into which a stick is inserted is selected in response to a command input by a user through the input/output interface 12, the controller 17 may control such that predetermined power is supplied to the heater.

FIG. 5 is a front perspective view of an aerosol generating device according to an embodiment of the present disclosure.

Referring to FIG. 5, a body 100 of the aerosol generating device 10 may be elongated. The body 100 may have the shape of a pipe with a hollow or cavity therein. For example, the body 100 may have a cuboid shape with rounded corners.

The body 100 may have at least one side open from the cavity formed therein. For example, the body 100 may be open at opposite sides in its longitudinal direction from the cavity therein.

The aerosol generating device 10 may include a head case 140 that defines one side (or a first side) of the body 100. The head case 140 may cover the one side of the body 100 that is open.

The head case 140 may have a hole in communication with an insertion space formed in the body 100, and a stick 20 may pass through the hole to be inserted into the insertion space. The head case 140 may further include a cap 160. The cap 160 may open and close the insertion space in a sliding manner.

The aerosol generating device 10 may include a cover 180 that defines the other side (or a second side) of the body 100. The other side may be opposite the one side at which the head case 140 is disposed. The other side may be a second end of the body 100 in the longitudinal direction. For example, the head case 140 may be disposed at a first end of the body 100 in the longitudinal direction, and the cover 180 may be disposed at the second end of the body 100 in the longitudinal direction. The cover 180 may cover the other side of the body 100 that is open.

A fixing unit 300 may be disposed in the body 100. The fixing unit 300 may be disposed between the head case 140 and the cover 180 inside the body 100. The fixing unit 300 may be fixed to one side of the inner surface of the body 100 inside the body 100. The body 100 may include therein a bracket (not shown) to fix or secure components, such as a battery, a heater, and the like, and the fixing unit 300 may be fixed to one side of the bracket.

Although not illustrated in FIGS. 1 to 3 and FIG. 5, the aerosol generating device 10 may constitute a system together with an additional cradle. For example, the cradle may be used to charge the battery 16 of the aerosol generating device 10. Alternatively, the heater may be heated in a state where the cradle and the aerosol generating device 10 are coupled to each other.

FIGS. 6 to 9 are respectively a front perspective view, an enlarged view, a front view, and a rear view of a fixing unit included in an aerosol generating device according to an embodiment of the present disclosure.

Hereinafter, directions of a fixing unit 300 are defined based on the orthogonal coordinate system. In the orthogonal coordinate system, the x-axis direction may be defined as the left-and-right direction of the fixing unit 300. Here, based on the origin, the +x-axis direction may be the right (or rightward) direction and the −x-axis direction may be the left (or leftward) direction. The y-axis direction may be defined as the front-and-rear direction of the fixing unit 300. Here, based on the origin, the +y-axis direction may be the rear (or rearward) direction, and the −y-axis direction may be the front (or forward) direction. The z-axis direction may be defined as the up-and-down direction of the fixing unit 300. Here, based on the origin, the +z-axis direction may be the up (or upward) direction, and the −z-axis direction may be the down (or downward) direction.

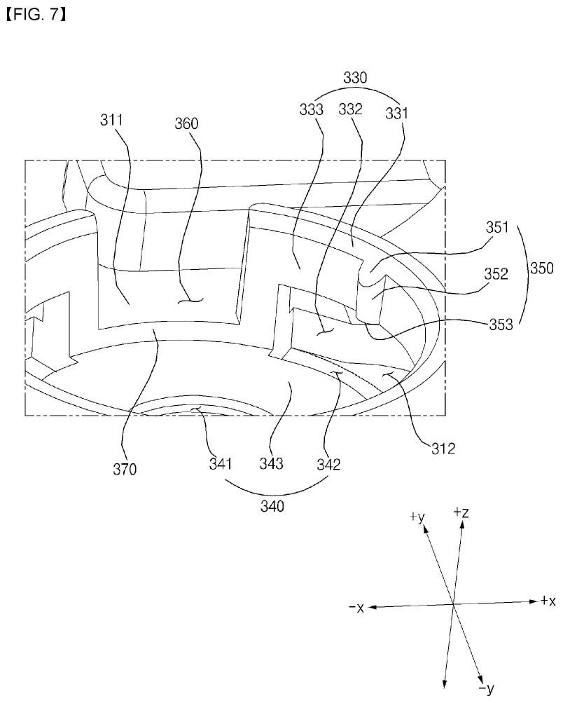

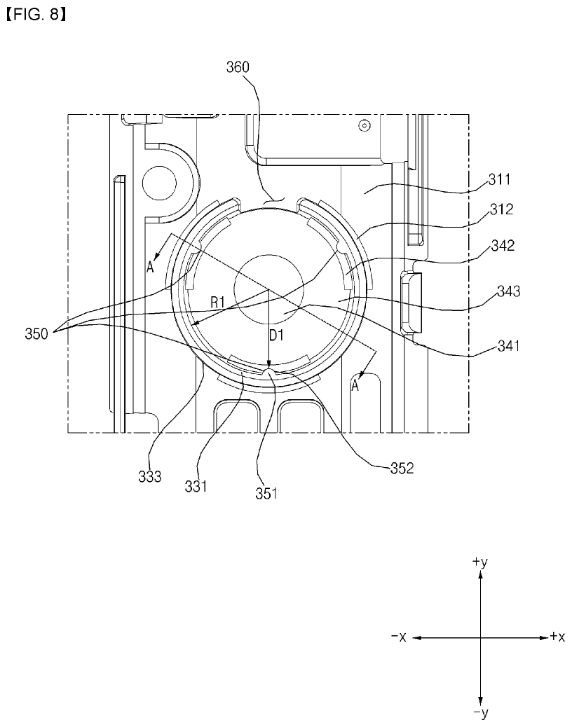

Referring to FIGS. 6 and 7, the fixing unit 300 may be provided in the body 100 of the aerosol generating device 10. The fixing unit 300 may include a fixing body 310 and a holder 320 provided on the fixing body 310.

The fixing body 310 may include a body surface 311 having at least a portion formed as a flat surface in the left-and-right direction and/or the front-and-rear direction, and the holder 320 may protrude from the body surface 311 in a direction intersecting the body surface 311 (e.g., the upward direction).

The fixing body 310 may be fixed inside the aerosol generating device 10. For example, the fixing body 310 may be accommodated in the body 100 of the aerosol generating device 10, and may be coupled or secured to the body 100 or the bracket inside the body 100. The fixing body 310 may include a coupling portion (not shown) to allow the fixing body 310 to be fixed to the body 100 or the bracket. The coupling portion may have an engaging protrusion or a fixing recess that corresponds to a fixing recess or an engaging protrusion formed on the body 100 or the bracket. However, the coupling portion is not limited thereto, and any type of coupling means capable of securing the fixing body 310 to the body 100 or the bracket may be used.

The holder 320 may include a support portion 330 and a seating portion 340.

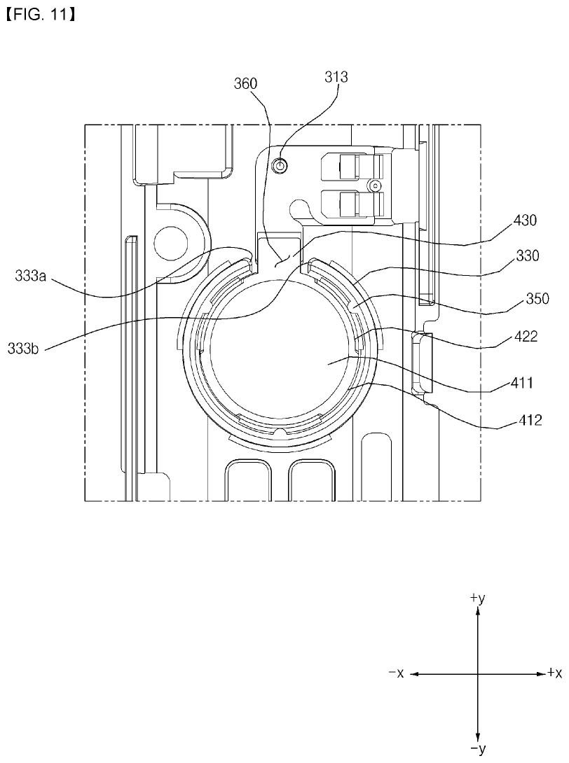

The holder 320 may define an accommodation space C therein. The accommodation space C may be open at top. A vibrator 400 (see FIG. 10) configured to generate vibration may be accommodated in the accommodation space C. The accommodation space C may have a shape corresponding to a case 410 (see FIG. 10) of the vibrator 400. For example, the accommodation space C may have a cylindrical shape elongated vertically. The support portion 330 may define a lateral portion or side of the accommodation space C, and the seating portion 340 may define a bottom of the accommodation space C.

The support portion 330 may protrude from the body surface 311 in one direction that intersects the body surface 311 (e.g., the upward direction). The support portion 330 may be formed along a circumferential direction of the accommodation space C or a circumferential direction of the vibrator 400. The support portion 330 may surround the perimeter (or circumference) of the accommodation space C or the perimeter (or circumference) of the vibrator 400. The support portion 330 may be provided in the form of a lateral wall 320 that surrounds the perimeter of the accommodation space C or the perimeter of the vibrator 400. For example, the support portion 330 may have the shape of a cylinder.

The support portion 330 may have a first opening 332. The support portion 330 may include a top surface on which a first inclined surface 331 is formed and a lateral wall 333 that is formed vertically and extends in the circumferential direction to surround the accommodation space C. The first opening 332 may be formed in at least a portion of the lateral wall 333 of the support portion 330.

The seating portion 340 may be formed on one side of the body surface 311. The seating portion 340 may be formed flat in a direction in which the body surface 311 is formed. The seating portion 340 may define a portion of the body surface 311. The seating portion 340 may be positioned inside the support portion 330. The seating portion 340 may be disposed on a lower side of the accommodation space C. The seating portion 340 may cover the bottom of the accommodation space C. The seating portion 340 may be configured to cover the bottom of the accommodation space C.

The holder 320 may include a protrusion portion 350. The protrusion portion 350 may protrude from an inner side or inner surface of the support portion 330 toward the accommodation space C along the perimeter or circumference of the support portion 330. The protrusion portion 350 may be disposed to face the inner side or inner surface of the support portion 330, or may be disposed to face a protrusion portion 350 on the opposite side. The protrusion portion 350 may be positioned between the support portion 330 and the vibrator 400. The protrusion portion 350 may be spaced apart from the seating portion 340. The protrusion portion 350 may protrude to an inside of the accommodation space C at an upper part of the support portion 330, and may be vertically spaced apart from the seating portion 340 that covers the bottom of the accommodation space C. The protrusion portion 350 may be integrally formed with the support portion 330.

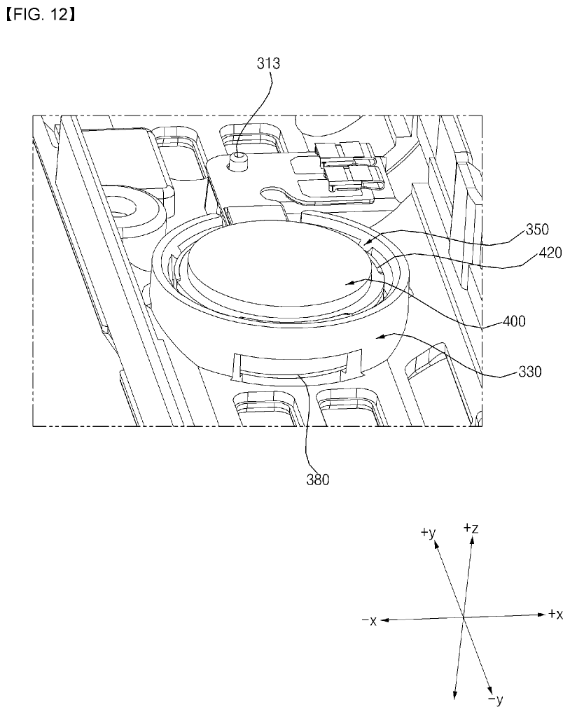

The protrusion portion 350 may support the vibrator 400 disposed in the accommodation space C, may come into contact with the vibrator 400, or may be in close contact with the vibrator 400. The support portion 330 may surround a lateral portion of the vibrator 400 to support the vibrator 400 laterally, the seating portion 340 may surround a lower portion of the vibrator 400 to support the vibrator 400 downwards, and the protrusion portion 350 may press the lateral portion or an upper portion of the vibrator 400 to support the vibrator 400 laterally and/or upwards (see FIGS. 11 and 12).

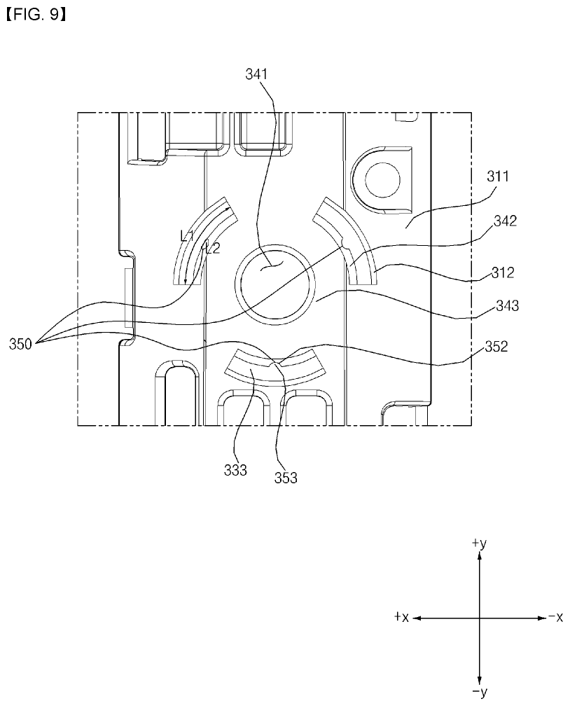

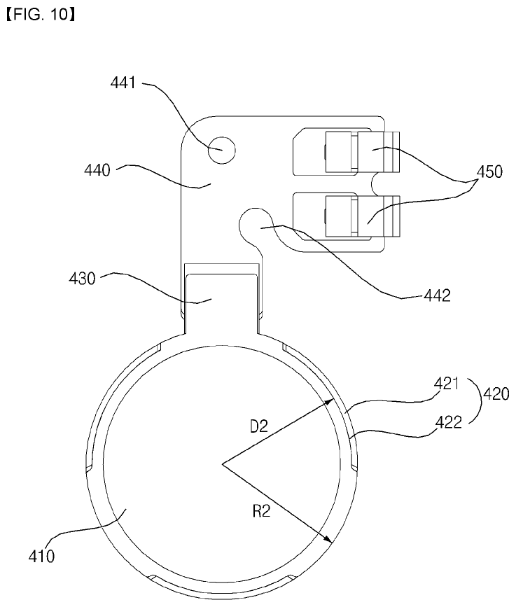

Referring to FIGS. 8 and 9, the protrusion portion 350 may include a plurality of fixing protrusions 350. The plurality of fixing protrusions 350 may be arranged to be spaced apart from each other along the circumference of the support portion 330. The plurality of fixing protrusions 350 may be spaced apart from each other along the circumference of the support portion 330 and may protrude to the inside of the accommodation space C. The plurality of fixing protrusions 350 may be arranged in a rotationally symmetric manner. For example, the protrusion portion 350 may include three fixing protrusions 350, and the fixing protrusions 350 may be arranged at intervals of 120 degrees in a rotationally symmetric manner with respect to a center of the accommodation space C.

As the plurality of fixing protrusions 350 are spaced apart from each other in a rotationally symmetric manner, the vibrator 400 may be stably supported or fixed in response to lateral and/or upward movement of the vibrator 400.

The protrusion portion 350 may protrude inward along the circumference of the support portion 330. The protrusion portion 350 may include a top surface 351, a lateral surface 352, and a bottom surface 353 (see FIG. 7). The top surface 351 of the protrusion portion 350 may be provided on a top (or upper end) of the protrusion portion 350, and the top surface 351 of the protrusion portion 350 may also define an inclined surface as an upper inner edge of the support portion 330 is tapered. The top surface 351 may be referred to as a second inclined surface 351. The second inclined surface 351 may be inclined from the top of the protrusion portion 350 to the inside of the accommodation space C or toward the vibrator 400. The second inclined surface 351 may be connected to or continuous with the first inclined surface 331 formed on a top of the support portion 330. The first inclined surface 331 of the support portion 330 may be inclined from the top of the support portion 330 to the inside of the accommodation space C, and the second inclined surface 351 of the protrusion portion 350 may be a surface that is connected to or continuous with the accommodation space C and protrudes from the inner lateral wall 333 of the support portion 330 toward the inside of the accommodation space C or the vibrator 400.

Meanwhile, the top surface of the support portion 330 may define a flat surface in the front-and-rear direction and/or the left-and-right direction, and the second inclined surface 351 of the protrusion portion 350 may be inclined from the top surface of the support portion 330 to the inside of the accommodation space C.

The lateral surface 352 of the protrusion portion 350 may protrude to the inside of the accommodation space C. For example, the lateral surface 352 of the protrusion portion 350 may protrude to the inside of the accommodation space C in a rounded manner. As another example, the lateral surface 352 may have a polygonal shape that protrudes to the inside of the accommodation space C. The bottom surface 353 of the protrusion portion 350 may be formed flat. The bottom surface 353 may define a flat surface in a direction in which the body surface 311 is formed.

When the vibrator 400 (see FIG. 10) is accommodated or inserted into the accommodation space C from above the accommodation space C, the second inclined surface 351 of the protrusion portion 350 may come into contact with at least one of a lateral surface 412 (see FIG. 14), a bottom surface 413 (see FIG. 14), and an edge (a boundary between the bottom surface 413 and the lateral surface 412 of the vibrator 400). As the second inclined surface 351 is inclined to the inside of the accommodation space C, the vibrator 400 may be easily accommodated or inserted into the accommodation space C.

The holder 320 may be an elastic body having elasticity. At least one of the support portion 330, the seating portion 340, and the protrusion portion 350 of the holder 320 may be an elastic body. For example, the holder 320 may be formed of plastic, such as polyurethane, rubber, such as silicone rubber or natural rubber, or other elastic materials. The support portion 330 and the protrusion portion 350 may include an elastic material, and may be integrally formed with each other to have elasticity.

Accordingly, the vibrator 400 may be easily accommodated or inserted into the accommodation space C, and noise (BSR (Buzz, Squeak, Rattle) noise), which may occur due to being hit on the support portion 330, the seating portion 340, and the protrusion portion 350 by the vibrator 400 accommodated or inserted into the accommodation space C, may be minimized. In addition, vibration of the vibrator 400 may be efficiently transferred to the electronic device, allowing information to be accurately notified to a user.

The fixing body 310 provided with the holder 320 may be an elastic body, and the holder 320 may be integrally formed with the fixing body 310. However, the present disclosure is not limited thereto.

Referring to FIGS. 8 and 9 together with FIG. 6, the support portion 330 may have a first opening 332. The support portion 330 may include a top surface on which the first inclined surface 331 is formed and a lateral wall 333 that is formed in the up-and-down direction and extends in the circumferential direction to surround the accommodation space C. The first opening 332 may be formed in at least a portion of the lateral wall 333 of the support portion 330.

The first opening 332 may be formed in a lower portion of the lateral wall 333. The first opening 332 may be referred to as a first slit 322. The first opening 332 may be formed below the protrusion portion 350. The protrusion portion 350 may be formed on a portion of the lateral wall 333 along the circumference of the support portion 330, and the first opening 332 may be formed below the protrusion portion 350. The first opening 332 may be positioned between the protrusion portion 350 and the seating portion 340. With respect to the up-and-down direction, the protrusion portion 350 may be disposed above the first opening 332, and the seating portion 340 may be positioned below the first opening 332. The first opening 332 may be provided in plurality. The plurality of first openings 332 may be arranged to be spaced apart from each other along the circumference of the support portion 330. The number of first openings 332 may correspond to the number of fixing protrusions 350 of the protrusion portion 350.

The first opening 332 may extend in a circumferential direction of the support portion 330. The first opening 332 may extend in a circumferential direction of the lateral wall 333. In the circumferential direction of the support portion 330, a length L1 of the first opening 332 extending in the circumferential direction may be greater than a length L2 of the protrusion portion 350 in the circumferential direction (see FIG. 9). A length L2 of the lateral surface 352 in the circumferential direction that the protrusion portion 350 protrudes from the lateral wall 333 of the support portion 330 toward the inside of the accommodation space C may be less than the length L1 of the first opening 332 in the circumferential direction. The protrusion portion 350 may be disposed above the first opening 332, and may be positioned between both (or opposite) ends in a circumferential direction of the first opening 332. A first end of the lateral surface 352 of the protrusion portion 350 that meets the lateral wall 333 of the support portion 330 may be spaced apart from a first end in the circumferential direction of the first opening 332, and a second end thereof may be spaced apart from a second end in the circumferential direction of the first opening 332. The protrusion portion 350 may be disposed at or adjacent to a central portion of the first opening 332 in the circumferential direction above the first opening 332.

As the protrusion portion 350 is formed on the support portion 330, and the first opening 332 is formed below the protrusion portion 350, the lateral wall 333 with the protrusion portion 350 may have a narrow width in the up-and-down direction compared to a lateral wall 33 without the protrusion portion 350 and the first opening 332. Accordingly, a portion of the lateral wall 333 where the protrusion portion 350 is formed may be more easily deformed than the other portion where the protrusion portion 350 is not formed.

When the vibrator 400 is accommodated or inserted into the accommodation space C, a portion of the lateral wall 333 where the protrusion portion 350 is formed may be easily deformed, allowing the vibrator 400 to be easily accommodated or inserted into the accommodation space C. Thus, damage to the vibrator 400 may be prevented.

A second opening 312 may be formed in the fixing body 310. The second opening 312 may be referred to as a second slit 312. The second opening 312 of the fixing body 310 may be formed at a position corresponding to the first opening 332. For example, the second opening 312 may extend to an outside of the accommodation space C on the body surface 311 of the fixing body 310, and may extend along the circumference of the support portion 330. The second opening 312 may be disposed below the first opening 332, and may be located outward relative to the first opening 332 with respect to the accommodation space C. The second opening 312 may overlap the first opening 332.

A third opening 342 may be formed in the seating portion 340. The third opening 342 of the seating portion 340 may be provided at a position corresponding to the first opening 332. For example, the third opening 342 may extend to the inside of the accommodation space C on a bottom surface 343 of the seating portion 340, and may extend along the circumference of the support portion 330. The third opening 342 may be disposed under the first opening 332, and may be located inward relative to the first opening 332 with respect to the accommodation space C. The third opening 342 may overlap the first opening 332.

The first opening 332, the second opening 312 and/or the third opening 342 may communicate with each other. The first opening 332, the second opening 312 and/or the third opening 342 may define one opening or slit to be in communication with each other. The second opening 312 may be formed below the protrusion portion 350, and the third opening 342 may be formed inside the accommodation space C at an imaginary lower boundary where the second opening 312 and the seating portion 340 or the body surface 311 meet, and the first opening 312 may be formed outside the accommodation space C. The second opening 312 and the third opening 342 may each be provided in plurality. The number of second openings 312 and the number of third openings 342 may correspond to the number of first openings 332.

As an opening in communication with the first opening 332 is formed not only in the lateral wall 333 of the support portion 330 but also in the seating portion 340 and the fixing body 310, the protrusion portion 350, the lateral wall 333 provided with the protrusion portion 350, and the seating portion 340 may be more easily deformed.

Accordingly, the vibrator 400 may be easily accommodated or inserted into the accommodation space C. The vibrator 400 may be securely supported by the support portion 330, the seating portion 340, and the protrusion portion 350 while preventing damage to the vibrator 400.

The seating portion 340 may be provided with a central opening 341. The central opening 341 may be referred to as a center circle 341. The bottom surface 343 of the seating portion 340 may have a shape corresponding to the circumference of the support portion 330. The central opening 341 may be formed inside the bottom surface 343. The central opening 341 may be spaced apart from the third opening 342. The central opening 341 may be formed in a central portion of the bottom surface 343 or in a position adjacent the central portion of the bottom surface 343.

Thus, coupling and removal of the vibrator 400 accommodated in the accommodation space C may be facilitated. In addition, when an adhesive portion 380 is disposed on the seating portion 340, attachment and detachment of the adhesive portion 380 may be facilitated. Upon the removal of the vibrator 400 and/or the adhesive portion 380, a user may push the vibrator 400 and/or the adhesive portion 380 upward through the central opening 341. This allows the vibrator 400 to be easily attached and detached from the fixing unit 300, thereby increasing the efficiency of product production.

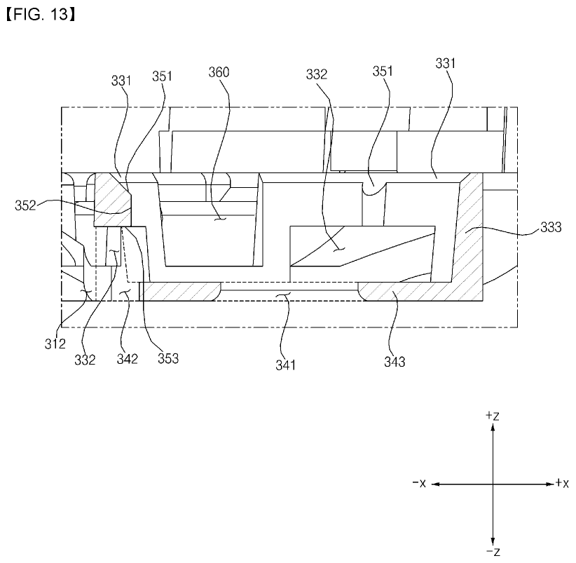

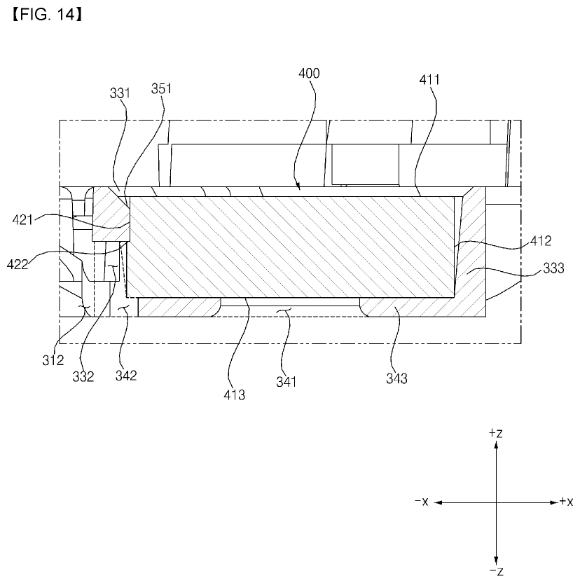

FIG. 10 is a view illustrating a vibrator coupled to a fixing unit according to an embodiment of the present disclosure, FIGS. 11 and 12 are views illustrating a state in which the vibrator of FIG. 10 is coupled to the fixing unit, and FIGS. 13 and 14 are cross-sectional views of the fixing unit.

Referring to FIG. 10, a vibrator 400 may be accommodated in the accommodation space C of the fixing unit 300 (see FIG. 6). The vibrator 400 may be a vibration motor that converts electrical energy into vibration. The vibrator 400 may include therein a vibrating portion (not shown) configured to vibrate up and down and/or front, rear, left, and right directions and a fixing portion (not shown) disposed adjacent to the vibrating portion, and a mutual electromagnetic force between the vibrating portion and the fixing portion causes the vibrating portion to vibrate. However, the structure of the vibrator 400 is not limited thereto, and various well-known vibration devices capable of transferring vibration to the outside may be employed.

The vibrator 400 may include a case 410, an electrode connecting portion 430, a connector 440, and an electrode 450.

The case 410 may define an outer appearance of the vibrator 400. The case 410 may have a cylindrical shape. The case 410 may accommodate therein the vibrating portion and the fixing portion, and may have the electrode connecting portion 430 at one side. The case 410 may include a top surface 411, a bottom surface 413 (see FIG. 14), and a lateral surface 412 that extends from the perimeter of the top surface 411 and the bottom surface 413 in the longitudinal direction. When the vibrator 400 is accommodated in the accommodation space C, the bottom surface 413 of the case 410 may come into contact with the bottom surface 343 of the seating portion 340.

The electrode connecting portion 430 may protrude from one side of the lateral surface 412 of the case 410, and an electrode (not shown) that can apply a current to the vibrating portion and the fixing portion may be disposed on one surface of the electrode connecting portion 430.

The connector 440 may have a first end in contact with the electrode connecting portion 430 and a second end provided with the electrode 450. The connector 440 may be a Flexible Printed Circuit Board (FPCB). The first end of the connector 440 may have a width corresponding to a width of the electrode connecting portion 430. The connector 440 may be bent in one direction. For example, the connector 440 may have an L-shape.

A portion at which the connector 440 is bent may be provided with a bay portion 442 curved inward of the connector 440. The bay portion 442 may be referred to as a recessed portion 442. As the bay portion 442 is formed at a portion where the connector 440 is bent, the bent portion of the connector 400 may be prevented from being damaged by vibration generated by the vibrator 400.

A fixing hole 441 may be formed in one side of the connector 440. The fixing hole 441 may be formed at a portion where the connector 440 is bent. The fixing hole 441 may be fixed to one side of the fixing unit 300. For example, a protruding portion 313, which protrudes upward from the body surface 311 of the fixing unit 300, is configured to pass through the fixing hole 441 while the vibrator 400 is accommodated in the accommodation space C, allowing the connector 440 of the vibrator 400 to be fixed to the fixing body 310 of the fixing unit 300.

The electrode 450 may be disposed on the second end of the connector 440. The electrode 450 may be electrically connected to a power source such as a battery or the like, allowing power to be applied to the vibrator 400.

Referring to FIGS. 11 and 12 together with FIG. 7, the fixing unit 300 may include a connecting groove 360 formed as one side of the support portion 330 is open. The connecting groove 360 may be formed in the circumferential direction of the support portion 330. A length of the connecting groove 360 in the circumferential direction may be equal to or greater than the width of the electrode connecting portion 430 of the vibrator 400. The support portion 330 may be rounded at both ends 333a and 333b where the support portion 330 meets the connecting groove 360.

An engaging projection 370 may be formed between the connecting groove 360 and the bottom surface 343 of the seating portion 340 (see FIG. 7). The seating portion 340 may be recessed downward from the body surface 311 of the fixing body 310. The seating portion 340 may form a step descending from the fixing body 310. The bottom surface 343 of the seating portion 340 may be positioned downward relative to the body surface 311. The engaging projection 370 may connect the body surface 311 and the bottom surface 343 of the seating portion 340.

The engaging projection 370 may be formed to be continuous with the lateral wall 333 of the support portion 330. With respect to the up-and-down direction, the engaging projection 370 may be disposed at a height corresponding to the first opening 332 of the support portion 330. A height of the engaging projection 370 may be less than a height of the first opening 332.

In a state where the vibrator 400 is accommodated in the accommodation space C, a portion of the lateral surface 412 of the vibrator 400 may be in contact with the engaging projection 370. The electrode connecting portion 430 formed on the lateral surface 412 of the vibrator 400 may protrude to the outside of the accommodation space C through the connecting groove 360 that is disposed over the engaging projection 370.

Accordingly, the vibrator 400 may be stably and firmly fixed to the accommodation space C.

An adhesive portion 380 may be provided on the seating portion 340 (see FIG. 12). The adhesive portion 380 may be formed of an elastic material. The adhesive portion 380 may have a shape corresponding to the bottom surface 343 of the seating portion 340. The adhesive portion 380 may be disposed between the bottom surface 343 of the seating portion 340 and the vibrator 400. One surface of the adhesive portion 380 may be in contact with the bottom surface 343 of the seating portion 340, and the other surface thereof may be in contact with one surface of the vibrator 400 that is accommodated in the accommodation space C.

The adhesive portion 380 may allow the vibrator 400 accommodated in the accommodation space C to be secured to the seating portion 340. An adhesive material may be applied to one surface of the adhesive portion 380 in contact with the bottom surface 343 of the seating portion 340. An adhesive material may be applied to the other surface of the adhesive portion 380 in contact with the vibrator 400.

Thus, the vibrator 400 may be securely fixed inside the holder 320 in the up-and-down direction, and noise, which may occur due to being hit on the seating portion 340 and/or the support portion 330 by the vibrator 400, may be prevented.

Referring to FIGS. 13 and 14 together with FIG. 8 and FIG. 10, in a state where the vibrator 400 is accommodated in the accommodation space C, the protrusion portion 350 may press the lateral surface 412 of the vibrator 400. The lateral surface 352 of the protrusion portion 350 may protrude to the inside of the accommodation space C in a rounded manner. When seen from above, a shortest distance D1 from a center of the accommodation space C or a center of the vibrator 400 to the protrusion portion 350 may be equal to or less than a radius R2 of the vibrator 400.

In a state where the vibrator 400 is accommodated in the accommodation space C, a portion of the lateral wall 333 of the support portion 330 where the protrusion portion 350 is formed may be bent in a direction away from the center of the accommodation space C, causing the lateral surface 412 of the vibrator 400 to be pressed by a restoring force of the lateral wall 333 and elasticity of the protrusion portion 350.

Of the lateral wall 333, a portion where the protrusion portion 350 is formed may be more easily deformed than the other portion where the protrusion portion 350 is not formed. In a state where the vibrator 400 is accommodated in the accommodation space C, the portion of the lateral wall 333 where the protrusion portion 350 is formed may be bent or spread outward of the accommodation space C to thereby press the vibrator 400.

Accordingly, the vibrator 400 may be securely fixed. In addition, the case 410 of the vibrator 400 may be prevented from being damaged due to an excessive force applied thereto, thereby preventing a decrease in lifespan of the vibrator 400.

A concave groove 420 (see FIG. 10) may be formed in the vibrator 400. A portion of an upper perimeter (or circumference) of the case 410 may be recessed to define the concave groove 420. The concave groove 420 may be formed by being recessed in the circumferential direction of the vibrator 400 at a boundary between the top surface 411 and the lateral surface 412 of the case 410.

The concave groove 420 may include a top surface 421 and a lateral surface 422. The top surface 421 may be a surface formed as the top surface 411 of the case 411 is recessed or cut out into the case 410 in the downward direction. The top surface 421 of the concave grove 420 may form a step with the top surface 411 of the case 410. The lateral surface 422 of the concave groove 420 may be a surface formed as the lateral surface 412 of the case 410 is recessed or cut out into the concave groove 420 in the left-and-right direction or the front-and-rear direction. The lateral surface 422 may form a step with the lateral surface 412 of the case 410. The lateral surface 422 may be positioned inward relative to the lateral surface 412 of the case 410. The lateral surface 422 may be formed in a shape corresponding to the circumference of the lateral surface 412 of the case 410. The lateral surface 422 may be rounded at both ends, where the lateral surface 422 meets the lateral surface 412 of the case 410.

The concave groove 420 may be provided in plurality, and the plurality of concave grooves 420 may be spaced apart from each other along the upper perimeter of the case 410. The fixing protrusion 350 of the protrusion portion 350 may be disposed corresponding to the position of the concave groove 420. The number of fixing protrusions 350 may correspond to the number of concave grooves 420.

In a state where the vibrator 400 is accommodated in the accommodation space C, the protrusion portion 350 may be inserted into the concave groove 420. The bottom surface 353 of the protrusion portion 350 may be in contact with the top surface 421 of the concave groove 420, and the lateral surface 352 of the protrusion portion 350 may be in contact with the lateral surface 422 of the concave groove 420 (see FIG. 14).

When seen from above, the shortest distance D1 from the center of the accommodation space C or the center of the vibrator 400 to the protrusion portion 350 may be equal to or less than a distance D2 from the center of the vibrator 400 to the lateral surface 422 of the concave groove 420. In a state where the vibrator 400 is accommodated in the accommodation space C, a portion of the lateral wall 333 of the support portion 330 where the protrusion portion 350 is formed may be bent in a direction away from the center of the accommodation space C or the center of the vibrator 400, causing the lateral surface 422 of the concave groove 420 to be pressed by a restoring force of the lateral wall 333 and elasticity of the protrusion portion 350. While the vibrator 400 is accommodated in the accommodation space C, the bottom surface 353 of the protrusion portion 350 may come into contact with the top surface 421 of the concave groove 420 to thereby support the top surface 421.

A portion of the lateral wall 333 where the protrusion portion 350 is formed may be more easily deformed than the other portion where the protrusion portion 350 is not formed. In a state where the vibrator 400 is accommodated in the accommodation space C, as the portion of the lateral wall 333 where the protrusion 350 is formed is bent or spread outward of the accommodation space C, the lateral surface 422 of the concave groove 420 may be pressed, allowing the bottom surface 353 of the protrusion portion 350 to support the top surface 411 of the concave groove 420.

Thus, the vibrator 400 may be securely fixed. In addition, the case 410 of the vibrator 400 may be prevented from being damaged by an excessive force applied thereto, thereby suppressing a decrease in lifespan of the vibrator 400.

As described above, according to at least one of the embodiments of the present disclosure, it is possible to fix the vibrator 400 firmly and stably.

According to at least one of the embodiments of the present disclosure, it is possible to prevent a decrease in lifespan of the vibrator 400 and damage to the fixing unit 300 due to being hit by the vibrator 400.

According to at least one of the embodiments of the present disclosure, it is possible to effectively transfer vibration of the vibrator 400 to a device while fixing the vibrator 400 firmly and stably, allowing information to be correctly notified to a user.

According to at least one of the embodiments of the present disclosure, it is possible to secure the vibrator 400 without an additional shock absorber, thereby simplifying the structure of the fixing unit 300 and reducing manufacturing costs.

According to at least one of the embodiments of the present disclosure, it is possible to allow the vibrator 400 to be easily attached and detached to and from the fixing unit 300, thereby increasing the efficiency of product production.

Referring to FIGS. 1 to 14, an aerosol generating device 10 according to an aspect of the present disclosure includes: a body 100 configured to provide an aerosol generating substance; a heater (110, 210) mounted to the body 100 and configured to heat the aerosol generating substance; a fixing body 310 installed inside the body 100; a holder 320 provided on the fixing body 310; and a vibrator 400 coupled to the holder 320. The holder 320 may include: a support portion 330 that protrudes from the fixing body 310 and extends along a circumferential direction of the vibrator 400; a seating portion 340 that is disposed inside the support portion 330 and supports the vibrator 400. The support portion 330 may include a first opening 332 formed in a circumferential direction of the support portion 330.

According to another aspect of the present disclosure, the support portion 330 may include a plurality of first openings 332, and the plurality of first openings 332 may be spaced apart from each other along a circumference of the support portion 330.

According to another aspect of the present disclosure, a second opening 312 may be formed in the fixing body 310 at a position corresponding to the first opening 332, and a third opening 342 may be formed in the seating portion 340 at a position corresponding to the first opening 332. The first opening 332, the second opening 312, and the third opening 342 may define one opening to be in communication with each other.

According to another aspect of the present disclosure, the holder 320 may include a protrusion portion 350 positioned between the support portion 330 and the vibrator 400, the protrusion portion 350 protruding from the support portion 330 to be in contact with the vibrator 400.

According to another aspect of the present disclosure, the first opening 332 may be positioned between the seating portion 340 and the protrusion portion 350.

According to another aspect of the present disclosure, with respect to the circumferential direction of the support portion 330, a length L1 of the first opening 332 may be greater than a length L2 of the protrusion portion 350. The protrusion portion 350 may be disposed above the first opening 332, and may be positioned between both ends of the first opening in a circumferential direction of the first opening 332.

According to another aspect of the present disclosure, the support portion 330 and the protrusion portion 350 may be integrally formed with each other to have elasticity.

According to another aspect of the present disclosure, the support portion 330 may include a first inclined surface 331 inclined from a top of the support portion 330 toward the vibrator 400. The protrusion portion 350 may include a second inclined surface that is formed on an upper end of the protrusion portion 350, connected to the first inclined surface 331, and inclined toward the vibrator 400.

According to another aspect of the present disclosure, the vibrator 400 may have a cylindrical shape. The protrusion portion 350 may have a lateral surface 352 protruding to be rounded toward the vibrator 400. A shortest distance D1 from a center of the vibrator 400 to the protrusion portion 350 may be equal to or less than a radius R2 of the vibrator 400.

According to another aspect of the present disclosure, the vibrator 400 may include a top surface 411, a lateral surface 412, and a concave groove 420 recessed in the circumferential direction of the vibrator 400 at a boundary between the top surface 411 and the lateral surface 412. The protrusion portion 350 may be disposed corresponding to a position of the concave groove 420 to be inserted into the concave groove 420. A shortest distance D1 from a center of the vibrator 400 to the protrusion portion 350 may be equal to or less than a distance D2 from the center of the vibrator 400 to a lateral surface of the concave groove 420.

According to another aspect of the present disclosure, the protrusion portion 350 may have a bottom surface 353 formed flat on a lower end of the protrusion portion 350. When the vibrator 400 is coupled to the holder 320, the bottom surface 353 of the protrusion portion 350 may contact with a top surface 421 of the concave groove 420, and a lateral surface 352 of the protrusion portion 350 may contact with the lateral surface 422 of the concave groove 420. The protrusion portion 350 may press the lateral surface 422 of the concave groove 420 as the support portion 330 is bent in a radially outward direction of the vibrator 400.

According to another aspect of the present disclosure, the holder 320 may further include a central opening 341 formed in a center of the seating portion 340 to be spaced apart from the first opening 332.

According to another aspect of the present disclosure, there may be further provided a connecting groove 360 formed as one side of the support portion 330 is open. The support portion 330 may be rounded at both ends 333a and 333b where the support portion 330 meets the connecting groove 360.

According to another aspect of the present disclosure, the seating portion 340 may form a step descending from the fixing body 310, and an engaging projection 370 may be formed between the seating portion 340 and the connecting groove 360.

According to another aspect of the present disclosure, the holder 320 may further include an adhesive portion 380 disposed on the seating portion 340. The adhesive portion 380 may secure the vibrator 400 to the seating portion 340.

Certain embodiments or other embodiments of the disclosure described above are not mutually exclusive or distinct from each other. Any or all elements of the embodiments of the disclosure described above may be combined or combined with each other in configuration or function.

For example, a configuration “A” described in one embodiment of the disclosure and the drawings, and a configuration “B” described in another embodiment of the disclosure and the drawings may be combined with each other. Namely, although the combination between the configurations is not directly described, the combination is possible except in the case where it is described that the combination is impossible.

The above detailed description is to be construed in all aspects as illustrative and not restrictive. The scope of the disclosure should be determined by reasonable interpretation of the appended claims, and all changes coming within the equivalency range of the disclosure are intended to be embraced in the scope of the disclosure.

What is claimed is:

1. An aerosol generating device comprising:
a body configured to provide an aerosol generating substance;
a heater mounted to the body and configured to heat the aerosol generating substance;
a fixing body installed inside the body;
a holder provided on the fixing body; and
a vibrator coupled to the holder,
wherein the holder comprises:
a support portion that protrudes from the fixing body and extends along a circumferential direction of the vibrator; and
a seating portion that is disposed inside the support portion and supports the vibrator, and
wherein the support portion comprises a first opening formed in a circumferential direction of the support portion.

2. The aerosol generating device of claim 1, wherein the support portion comprises a plurality of first openings, and
wherein the plurality of first openings are spaced apart from each other along a circumference of the support portion.

3. The aerosol generating device of claim 1, wherein a second opening is formed in the fixing body at a position corresponding to the first opening,
wherein a third opening is formed in the seating portion at a position corresponding to the first opening, and
wherein the first opening, the second opening, and the third opening define one opening to be in communication with each other.

4. The aerosol generating device of claim 1, wherein the holder comprises a protrusion portion positioned between the support portion and the vibrator, the protrusion portion protruding from the support portion to be in contact with the vibrator.

5. The aerosol generating device of claim 4, wherein the first opening is positioned between the seating portion and the protrusion portion.

6. The aerosol generating device of claim 5, wherein, with respect to the circumferential direction of the support portion, a length of the first opening is greater than a length of the protrusion portion, and
wherein the protrusion portion is disposed above the first opening and is positioned between both ends of the first opening in a circumferential direction of the first opening.

7. The aerosol generating device of claim 4, wherein the support portion and the protrusion portion are integrally formed with each other to have elasticity.

8. The aerosol generating device of claim 4, wherein the support portion comprises a first inclined surface inclined from a top of the support portion toward the vibrator, and
wherein the protrusion portion comprises a second inclined surface that is formed on an upper end of the protrusion portion, connected to the first inclined surface, and inclined toward the vibrator.

9. The aerosol generating device of claim 4, wherein the vibrator has a cylindrical shape,
wherein the protrusion portion has a lateral surface protruding to be rounded toward the vibrator, and
wherein a shortest distance from a center of the vibrator to the protrusion portion is equal to or less than a radius of the vibrator.

10. The aerosol generating device of claim 4, wherein the vibrator comprises:
a top surface;
a lateral surface; and
a concave groove recessed in the circumferential direction of the vibrator at a boundary between the top surface and the lateral surface,
wherein the protrusion portion is disposed corresponding to a position of the concave groove to be inserted into the concave groove, and
wherein a shortest distance from a center of the vibrator to the protrusion portion is equal to or less than a distance from the center of the vibrator to a lateral surface of the concave groove.

11. The aerosol generating device of claim 10, wherein the protrusion portion has a bottom surface formed flat on a lower end of the protrusion portion,
wherein, when the vibrator is coupled to the holder, the bottom surface of the protrusion portion contacts with a top surface of the concave groove, and a lateral surface of the protrusion portion contacts with the lateral surface of the concave groove, and
wherein the protrusion portion presses the lateral surface of the concave groove as the support portion is bent in a radially outward direction of the vibrator.

12. The aerosol generating device of claim 1, wherein the holder further comprises a central opening formed in a center of the seating portion to be spaced apart from the first opening.

13. The aerosol generating device of claim 1, further comprising a connecting groove formed as one side of the support portion is open,
wherein the support portion is rounded at both ends where the support portion meets the connecting groove.

14. The aerosol generating device of claim 13, wherein the seating portion forms a step descending from the fixing body, and
wherein an engaging projection is formed between the seating portion and the connecting groove.

15. The aerosol generating device of claim 1, wherein the holder further comprises an adhesive portion disposed on the seating portion, and
wherein the adhesive portion secures the vibrator to the seating portion.
